(19) United States
(12) Patent Application Publication
(10) Pub. No.: US 2018/0211043 A1
(43) Pub. Date: Jul. 26, 2018

(54) Blockchain Based Security for End Points

(71) Applicant: SparkCognition, Inc., Austin, TX (US)

(72) Inventor: Syed Mohammad Amir Husain, Round Rock, TX (US)

(21) Appl. No.: 15/413,995

(22) Filed: Jan. 24, 2017

(51) Int. Cl. G06F 21/57; H04L 29/06; G06F 21/55; G06N 5/02

(52) U.S. Cl. CPC G06F 21/57; G06N 5/02; G06F 21/55; H04L 63/1466

(57) ABSTRACT

Systems and methods are provided for distributing security information. The systems and methods include a network having a plurality of nodes for storing a plurality of linearly integrated data records in a distributed file system, each linearly integrated data record including security information, a client installed on each node, each client configured to obtain the security information from at least one other node in the network, and a module contained within each client for delivering the obtained security information to an endpoint security application of the corresponding node.

### FIELD OF THE INVENTION

The present invention relates in general to computer anti-virus detection and distribution and, in particular, to a Blockchain based security ledger to enable security and prevent man in the middle manipulation of content.

### BACKGROUND

Antivirus applications typically update their virus file signatures as new viruses are discovered and as cures for these viruses are developed, and make these updated file signatures available to users on a periodic basis (e.g. monthly, quarterly, etc.). For example, an antivirus program may rely on delivery of updates to specify the file signatures corresponding to malware, viruses and other undesirable files. These updates can also contain lists of IP addresses, host names and other network addresses that correspond to undesirable sources and locations on the network.

This list of file signatures (sometimes known as a blacklist catalog) is used to enable the endpoint system to defend itself in the event that an undesirable file is downloaded by it, or uploaded to it, or if the end user or a program running on the endpoint system attempts to establish communication with a blacklisted network node. Importantly, if the signature of a certain virus or other undesirable file is not contained in any of the file signatures, that virus will not be detected by the endpoint security systems. Therefore, it is extremely important to keep the file signatures as current as possible.

Newer, heuristic, Cognitive and AI based anti-malware systems may not rely on explicit file checksum signatures, but rather copies of learned weights that reflect the learning and/or training of machine learning methodologies on large samples of malware. They might also be executable or computable heuristics or other functions that capture knowledge regarding how a threat operates, and look to validate such behavior. The common element in all these approaches is that knowledge, in the form of blacklists, or in the form of rules, heuristics and/or statistical weights is being transmitted from a host (or a group of hosts behind a firewall mechanism, or a Content Delivery Network) to a destination (client) across a network.

An underlying assumption in such a system is that the downloaded blacklist catalog can be trusted. Conventional means of verification such as MD5 checksums or other techniques (e.g. SHA) are used validate if the downloaded blacklist catalog is indeed untampered. However, a drawback of this system is that still assumes that the source from which the checksum or verification file was downloaded is trustable. This leaves the downloaded blacklist catalog vulnerable to a “man in the middle” attack, whereby the client endpoint system thinks that it is connected to (1) a trustworthy source of blacklist information, and (2) the corresponding verification file, whereas in reality both of these may have been doctored, with the doctored verification file confirming that the provided blacklist catalog is untampered. In this case, despite the MD5/SHA checksums matching, the actual contents of the file would not be trustworthy and could be a significant security risk. In other cases, signatures of important operating system components of security infrastructure software may be added incorrectly to the blacklisted items, preventing these from functioning properly.

Blockchain technology is most widely known as the technology behind the popular cryptocurrency Bitcoin. A blockchain creates a history of data deposits, messages, or transactions in a series of blocks where each block contains a mathematical summary, called a hash, of the previous block. This creates a chain where any changes made to a block will change that block's hash, which must be recomputed and stored in the next block. This changes the hash of the next block, which must also be recomputed and so on until the end of the chain. Crypto currencies such as Bitcoin and services to provide a distributed, trusted ledger that uses encryption in order to allow for information storage with no need for a single arbiter, or single trusted source. It has been shown that the Blockchain system is secure as long as less than (n/2)+1 systems on the network have been compromised, where n is the total participants on the Blockchain network.

There is a need for an approach to efficiently distribute and update file signatures definitions. Such an approach would allow efficient virus definition updating while preserving existing data file formats, and preventing “man in the middle” attacks as described above.

### SUMMARY

The present invention provides a Blockchain based security ledger to enable security and prevent man in the middle manipulation of content.

In some embodiments, a system is provided for distributing security information. The system includes a network having a plurality of nodes for storing a plurality of linearly integrated data records in a distributed file system, each linearly integrated data record including security information. The system also includes a client installed on each node, each client configured to obtain the security information from at least one other node in the network. The system also includes a module contained within each client for delivering the obtained security information to an endpoint security application of the node corresponding to that client.

In some embodiments, a method for distributing security information is provided. The method includes storing, by a network having a plurality of nodes, a plurality of linearly integrated data records in a distributed file system, each linearly integrated data record including security information. The method also includes obtaining, by a client installed on one of the plurality of nodes, security information from the network. The method also includes delivering, by a module contained within the client, the obtained security information to an endpoint security application of the node corresponding to that client.

In some embodiments, a method for updating computer virus definitions is provided. The method includes storing, by a network having a plurality of nodes, blockchain having a plurality of linearly integrated data records in a distributed file system, each linearly integrated data record including a virus definition. The method also includes obtaining, by a client installed on one of the plurality of nodes, the blockchain from the network. The method also includes delivering, by a module contained within the client, the virus definitions of the blockchain to an endpoint security application of the node corresponding to that client. The method also includes instantiating, by the endpoint security system, the virus definitions of the blockchain. The method also includes analyzing data stored on an endpoint client system associated with the endpoint security application to detect one or more security threats associated with the virus definitions. The method also includes taking an action with respect to operation of the endpoint client system in response to the detection of the one or more security threats.

Still other embodiments of the present invention will become readily apparent to those skilled in the art from the following detailed description, wherein is described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF DRAWINGS

The features and advantages of the invention will become apparent from the following detailed description when considered in conjunction with the accompanying drawings. Where possible, the same reference numerals and characters are used to denote like features, elements, components or portions of the invention. It is intended that changes and modifications can be made to the described embodiment without departing from the true scope and spirit of the subject invention as defined by the claims.

FIG. 1 illustrates a system for distributing security information in accordance with various embodiments.

FIG. 2 illustrates a method for distributing security information in accordance with various embodiments.

### DETAILED DESCRIPTION

The present invention provides a Blockchain based security ledger 109 to enable security and prevent man in the middle manipulation of content.

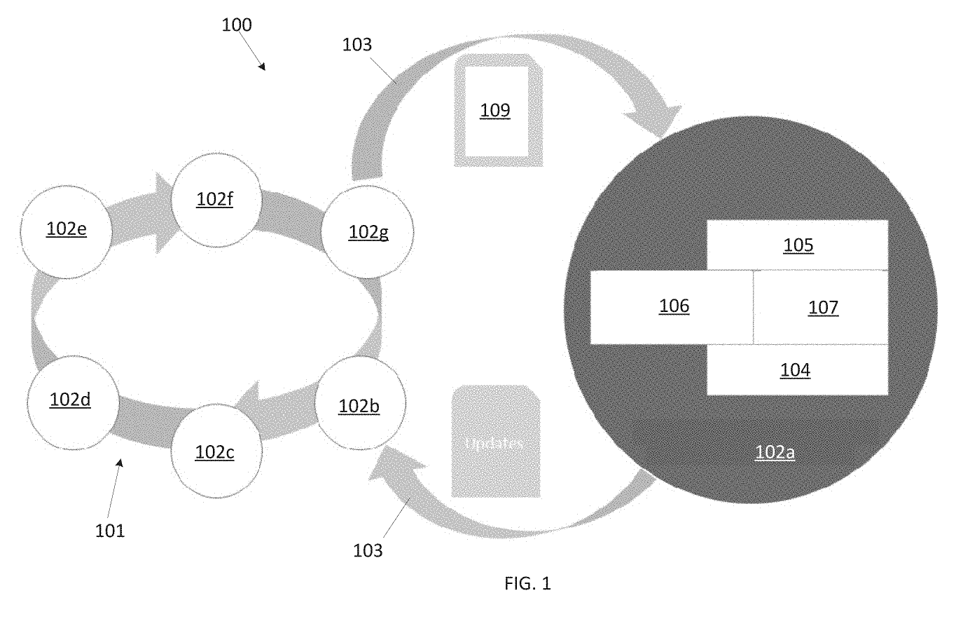

According to an embodiment of the present invention, FIG. 1 is a block diagram showing a networked computing environment 100, including a system for distributing security information, in accordance with the present invention. The networked computing environment 100 includes a blockchain network 101 composed of plurality of nodes 102a-g, including a client node 102a, via one or more connections 103. The blockchain network 101 provides client services, such as information retrieval and file serving. The connection, in some embodiments, can be with a direct connection, over a dialup connection, via an intranetwork, or by a combination of the foregoing or with various other network configurations and topologies, as would be recognized by one skilled in the art.

In some embodiments, the blockchain network 101 includes security information stored as a plurality′ of discrete, linearly integrated data records or “blocks” within the security ledger 109. Security information, for example, can include whitelisted, blacklisted, or otherwise relevant IP addresses, host names, file signatures, machine learning models, statistics information used to isolate files, processes, network end points, hardware IDs, peripheral IDs, driver signatures, OS file signatures, data sequences, binary sequences, machine code sequences, web addresses, file checksums, strings, host information, identifiers, or combinations thereof. Suitable persistent storage devices on the blockchain network include randomly accessible devices, such as hard drives and rewriteable media, although other forms of persistent storage devices could also be used by or incorporated into the blockchain network 101. In use, individual directories, files, databases, and records of the security ledger 109 are stored in the distributed file system throughout the nodes 102a-g of the blockchain network 101.

The client node 102a can potentially be exposed to computer viruses by virtue of having interconnectivity with outside machines. As protection, the client node 102a can include, for example, security software 107 for executing operations to scan for the presence of and to clean off any computer viruses. An exemplary security software 107 is the SparkSecure® product, by SparkCognition, Inc., Austin, Tex.

Security software 107 must be periodically updated with new computer virus definitions to continue to provide up-to-date anti-virus protection. Thus, the client node 102 can include a SecureUpdateClient 104 module that executes an updating service. The SecureUpdateClient 104 module integrates with security software 107, an API update module 105, and a blockchain client 106 to obtain the security information stored in the distributed file system of the blockchain network 101, for subsequent use in performing virus scanning and cleaning. In some embodiments, such security content or information can be, for example, added by a system or user with a maintainer/administrator (sometimes referred to as a senior validator in Blockchain parlance) authorization or any other system, user, or party responsible for delivering security updates.

The individual nodes 102a-g of the Blockchain network 101, such as client node 102a, can be programmed digital computing devices having a central processing unit (CPU), random access memory (RAM), non-volatile secondary storage, such as a hard drive or CD ROM drive, network interfaces, and/or peripheral devices, including user interfacing means, such as a keyboard or display. Program code, including software programs, and data are loaded into the RAM for execution and processing by the CPU and results are generated for display, output, transmittal, or storage. The applications are envisioned to be programmed in a high level language such as Java™, JavaScript, C++, C#, C, Visual Basic™, Swift, or Objective-C.

In one embodiment, blockchain network 101 is a private network established by an enterprise in order to deliver updates and security relevant content to its own and partner systems. In another embodiment, blockchain network 101 is deployed by a security vendor to distribute security data to its customers, clients and partners. In yet another embodiment, blockchain network 101 is accessible over the public internet, or it may be restricted to allow non-public systems to communicate with each other.

In some embodiments, security content is added to the blockchain network 101 by a maintainer/administrator (senior validator) or a party responsible for delivering security updates. This is performed by providing a number of system nodes with the relevant security information. Each one of these updates would arrive into the network from individual delivery points and would be verified by other systems before the information is added to the blockchain network 101.

For example, in some embodiments the validation can be performed by validator nodes by making use of the longest chain consensus rule inherent in the Blockchain protocol. In some embodiments, for example, as new blocks containing model or blacklisted signature information are added, the new signatures are accompanied by offending data/binary sequences that a previous version of the anti-malware model “matched”. The likelihood of match would be captured as a numeric value (e.g. 78%) and encoded as part of the update. That is, a confirmed malicious code can be added as a model or blacklisted signature but sophisticated viruses and malware typically permit various variations in the code to avoid detection and execute different functions. Therefore, the signature can also be accompanied, for example, by a library of similar but at least partially different code previously detected within the system that could be a variation of the signature code. In some embodiments, the library can include a likelihood of match as a numeric value (e.g., as a percentage match between each similar code in the library and the confirmed code associated with the signature). In some embodiments, such similar code can be identified as any code meeting a predetermined percentage similarity threshold (e.g., 50% similar, 75% similar, 90% similar, or any other threshold). Thus, the accompanying code in the library can be referenced to either blacklist such similar code or to indicate a need to exercise increased scrutiny of such code.

Validator nodes can then look at the new update and run the existing model to determine if the validator node produces the same likelihood percentage as reported by the original contributor. If the validator nodes confirm the update, the validator nodes can “validate” this block as a legitimate addition to the blockchain.

In another embodiment, the security content in question is added to blockchain network 101 by individual endpoint systems or servers, such as client node 102a, that are equipped with security software that can identify security transgressions. For example in some embodiments, the security software 107 can identify an IP address that corresponds to a brute force attack directed at the system in question. In some embodiments, the security software 107 can identify a host name corresponding to a source from where a known malware file was downloaded. Upon detection of a security transgression, the client node 102a (also referred to as an endpoint system) can update the relevant information to the blockchain network 101 for use by the other nodes 102a-g.

In another embodiment, each endpoint system can contribute information to blockchain network 101 but individual clients would have the ability to read the distributed security ledger 109 enabled by blockchain network 101 and decide if the update applies to them based on criteria such as the number of individual systems that have reported the information, the specific IDs of the systems that are reporting the information, the relevance of the information to the applications, hardware, peripheral and OS configuration on the client making the decision.

The security content stored in the Blockchain can be read by any instance of a “BlockchainClient” module and provided to the security software integrated via a “SecureUpdateClient” in push or pull fashion, I.e. By proactively ‘pushing’ the content to an application, or storing the obtained content in a file, database or other form store until the relevant security application requests it.

In order to facilitate the extraction of the obtained content, which may be in text form, binary form or as a special case of the binary form, as a serialized data structure, client 12 includes an UpdateAPI module which provides convenient read/write functions that act as ‘getters’ and ‘setters’ for the stored security information. For example, these methods could include:

getIPBlacklist( )

token = ConnectToBlockChain( )
bc = DownloadBlockChain(token)
blist = ParseBlockChainToFindLatestIPBlackListStored(bc)
l = RemoveExtraneousMetadata(blist)
return(l)

updateMLModel( )

token = ConnectToBlockChain( )
bc = DownloadBlockChain(token)
mlmodel = = ParseBlockChainToFindLatestPublishedMLModel(bc)
m = DeSerializeModel(mlmodel)
ReinstantiateLocalLearningAlgorithWModel(m)

isIPinBlacklist(iPAddress)

l = getIPBlackList( )
bool = SearchFor(ipAddress,l)
return(bool)

isSigBlacklisted(fileSignature)

l = getSigBlackList( )
bool = SearchFor(fileSignature,l)
return(bool)

computeMalwareLikelihood(data)

likelihood = −1
if(!recentUpdate) {

updateMLModel( )

} else {

likelihood_score = MLClassifier(data)

}
return(likelihood)

and similar methods.

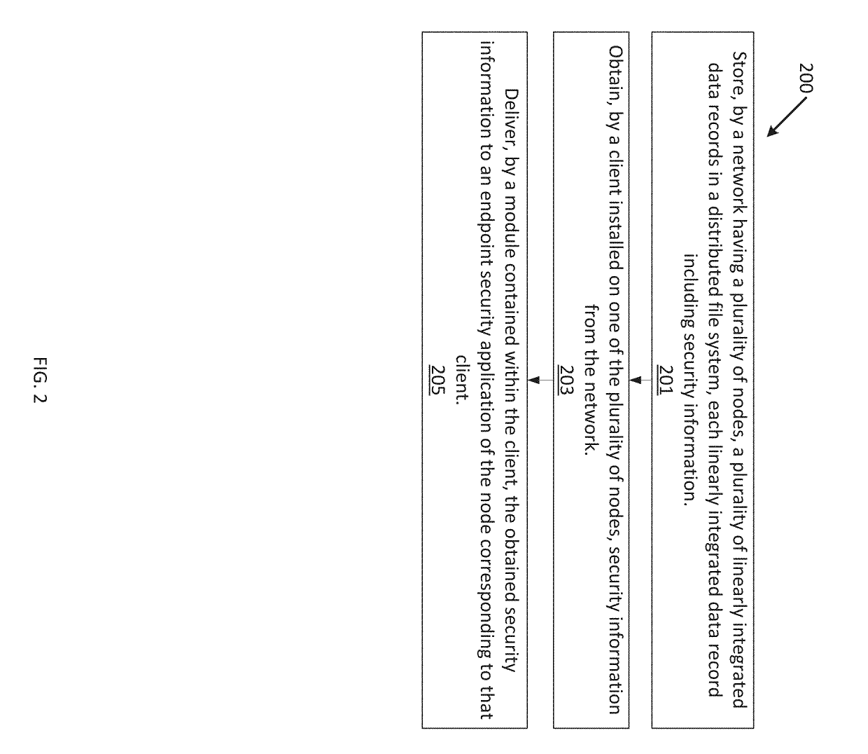

As shown in FIG. 2, a method for obtaining security information is provided in accordance with various embodiments. In some embodiments, the method includes a step of storing 201, by a blockchain network, at least one virus definition file in a distributed security ledger. In some embodiments, the method includes a step of obtaining 203, by each of a plurality of blockchain clients, security information from the blockchain network. In some embodiments, the method includes a step of delivering 205, by an integration module of each blockchain client, the obtained security information to an endpoint security application.

The step of storing 201, can be performed, in accordance with various embodiments, for example, by dynamically or statically integrating a Blockchain client, or a component or client that is capable of interacting with a Blockchain network, with end point security software as discussed above with reference to FIG. 1. Methods, in accordance with various embodiments can also include use of endpoint security software that is capable of accessing any one of memory, BIOS, files and network data on the client computer system. In some embodiments, methods can also include receiving security updates in the form of blacklisted file checksums, strings, IPs or host information, binary sequences or other identifiers, from a Blockchain network. Alternatively, in some embodiments, methods can include, in the case of Cognitive or AI-powered anti-malware technology, receiving a set of features, pre-developed models, weights, vectors or heuristics that can be used to evaluate local data. In some embodiments, the methods can include instantiating the blacklists or models and using them to analyze local data. Methods, in accordance with various embodiments can also include, in the event that a likely match between data and obtained security information occurs, taking necessary actions with respect to the endpoint system that may include, for example, one or more of blocking the execution of an object code stored on the endpoint client system, deleting or purging the object code or data stored on the endpoint client system, rejecting a connection to or from a host system, shutting down the endpoint client system, quarantining at least a portion of the object code or data stored on the endpoint client system, or combinations thereof.

In some embodiments, methods can also include using the blacklists or models to analyze local data and if additional types of threats or malware are found, write back to the blockchain a record of this discovery. For example, a file with checksum XYZ matched with 85% probability in response to an evaluation by Cognitive Model version 0.2.333 on date ABC on client EFG. The types of information captured in this transaction can, in some embodiments, also include samples of offending data, IP address information of where the incident took place, owner, corporate identifier information and additional such metadata.

The foregoing described embodiments of the invention are provided as illustrations and descriptions. They are not intended to limit the invention to precise form described. In particular, it is contemplated that functional implementation of the invention described herein may be implemented equivalently in hardware, software, firmware, and/or other available functional components or building blocks. No specific limitation is intended to a particular security token operating environment. Other variations and embodiments are possible in light of above teachings, and it is not intended that this Detailed Description limit the scope of invention, which is further defined and claimed below:

1. A system for distributing security information, comprising:
a network having a plurality of nodes for storing a plurality of linearly integrated data records in a distributed file system, each linearly integrated data record including security information;
a client installed on each node, each client configured to obtain the security information from at least one other node in the network; and
a module contained within each client for delivering the obtained security information to an endpoint security application of the node corresponding to that client.

2. The system of claim 1, wherein the security information further comprises a virus definition file.

3. The system of claim 2, wherein the network is accessible over the public internet.

4. The system of claim 2, further comprising a security information provider updating the network with additional security information.

5. The system of claim 2, wherein each client is equipped with security software that can identify security transgressions and add new security information to the network upon detection of the security transgression.

6. The system of claim 5, wherein each client obtains security information based on relevancy criteria, wherein the relevancy criteria further comprises whether the updated security information applies to said client.

7. The system of claim 6, wherein the relevancy criteria further comprises the number of individual clients that have reported the security information.

8. The system of claim 6, wherein the relevancy criteria further comprises the specific IDs of the systems that are reporting the security information.

9. The system of claim 6, wherein the relevancy criteria further comprises the relevance of the security information to said client.

10. The system of claim 1, wherein the security information is delivered to the endpoint security application by a push.

11. A method for distributing security information comprising:
storing, by a network having a plurality of nodes, a plurality of linearly integrated data records in a distributed file system, each linearly integrated data record including security information;
obtaining, by a client installed on one of the plurality of nodes, security information from the network; and
delivering, by a module contained within the client, the obtained security information to an endpoint security application of the node corresponding to that client.

12. The method of claim 11, wherein the security information includes one or more of blacklisted file checksums, strings, IP addresses, host information, binary sequences, identifiers, or combinations thereof.

13. The method of claim 11, wherein:
the endpoint security application includes a cognitive or artificial intelligence module; and
the security information includes one or more of features, pre-developed models, weights, vectors, heuristics, or combinations thereof configured to permit the endpoint security application to analyze data stored on an endpoint client system associated with the endpoint security application to detect one or more security threats associated with the security information.

14. The method of claim 11, further comprising:
instantiating the obtained security information by the endpoint security system;
analyzing data stored on an endpoint client system associated with the endpoint security application to detect one or more security threats associated with the security information; and
taking an action with respect to operation of the endpoint client system in response to the detection of the one or more security threats.

15. The method of claim 14, wherein the action includes one or more of blocking the execution of an object code stored on the endpoint client system, deleting or purging the object code or data stored on the endpoint client system, rejecting a connection to or from a host system, shutting down the endpoint client system, quarantining at least a portion of the object code or data stored on the endpoint client system, or combinations thereof.

16. A method for updating computer virus definitions comprising:
storing, by a network having a plurality of nodes, blockchain having a plurality of linearly integrated data records in a distributed file system, each linearly integrated data record including a virus definition;
obtaining, by a client installed on one of the plurality of nodes, the blockchain from the network;
delivering, by a module contained within the client, the virus definitions of the blockchain to an endpoint security application of the node corresponding to that client;
instantiating, by the endpoint security system, the virus definitions of the blockchain;
analyzing data stored on an endpoint client system associated with the endpoint security application to detect one or more security threats associated with the virus definitions; and
taking an action with respect to operation of the endpoint client system in response to the detection of the one or more security threats.
